(19) United States
(12) Patent Application Publication
(10) Pub. No.: US 2003/0063795 A1
(43) Pub. Date: Apr. 3, 2003

(54) Face recognition through warping

(75) Inventors: Miroslav Trajkovic, Ossining, NY (US); Vasanth Philomin, Briarcliff Manor, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/966,406

(22) Filed: Sep. 28, 2001

(51) Int. Cl. G06K 9/62

(52) U.S. Cl. 382/159

(57) ABSTRACT

A system and method for classifying facial images from a partial view of a facial image, the method comprising the steps of: training a classifier device for recognizing facial images, the classifier device being trained with input data associated with a facial image of a subject; detecting a partial view of a subject's facial image; warping the partial view of the subject's facial image onto a frontal image to obtain a warped image of the subject; and, classifying the warped image according to a classification method performed by the trained classifier device.

### BACKGROUND OF THE INVENTION

1. Field of the Invention

The present invention relates to face recognition systems and particularly, to a system and method for performing face recognition using warping of a facial image view onto a full frontal image.

2. Discussion of the Prior Art

Face recognition is an important research area in human computer interaction and many algorithms and classifier devices for recognizing faces have been proposed.

Typically, face recognition systems store a full facial template obtained from multiple instances of a subject's face during training of the classifier device, and compare a single probe (test) image against the stored templates to recognize/identify the individual/subject's face. Specifically, multiple instances of a subject's face are used to train the system and then a full face of that subject is used as a probe to recognize/identify the face.

FIG. 1 illustrates a traditional classifier device 10 comprising, for example, a Radial Basis Function (RBF) network having a layer 12 of input nodes, a hidden layer 14 comprising radial basis functions and an output layer 18 for providing a classification. A description of an RBF classifier device is available from commonly-owned, co-pending U.S. patent application Ser. No. 09/794,443 entitled CLASSIFICATION OF OBJECTS THROUGH MODEL ENSEMBLES filed Feb. 27, 2001, the whole contents and disclosure of which is incorporated by reference as if fully set forth herein.

As shown in FIG. 1, a single probe (test) image 25 including input vectors 26 comprising data representing pixel values of the facial image, is compared against the stored templates for face recognition. It is well known that face recognition from a single face image is a difficult problem, especially when that face image is not completely frontal. Thus, for example, when only the profile or partial view of the subject is available, then the system has to be trained on the different views as well for proper recognition.

More particularly, while it is the case that existing face recognition systems typically perform face recognition on the frontal view faces, the performance of such systems gradually decreases with the increasing changes in face pose, and they almost completely fail, for face pose angles greater than 15 degrees.

It would be highly desirable to provide a face recognition system and method that enables the “warping” of a profile/partial view of a subject's face onto a full frontal image which warped image may be used for recognition.

### SUMMARY OF THE INVENTION

Accordingly, it is an object of the present invention to provide a face recognition system and method that enables the warping of a profile/partial view of a subject's face onto a full frontal image, which warped image may then be used for recognition.

It is a further object of the present invention to provide a face recognition system and method that enables the warping of a profile/partial view of a subject's face onto a full frontal image which may then be used for recognition, and obviates the need for re-training a classifier with different profiles/partial views of the individual.

In accordance with the principles of the invention, there is provided a system and method for classifying facial images from a partial view of a facial image, the method comprising the steps of: training a classifier device for recognizing facial images, the classifier device being trained with input data associated with a facial image of a subject; detecting a partial view of a subject's facial image; warping the partial view of the subject's facial image onto a frontal image to obtain a warped image of the subject; and, classifying the warped image according to a classification method performed by the trained classifier device.

Advantageously, the performance of such face recognition systems increases when utilizing the warping algorithm described herein.

### BRIEF DESCRIPTION OF THE DRAWINGS

Details of the invention disclosed herein shall be described below, with the aid of the figure listed below, in which:

FIG. 1 is a block diagram depicting the method for carrying out face recognition using warping of a facial image view according to the present invention.

### DETAILED DESCRIPTION OF THE PREFERRED EMBODIMENTS

The present invention is directed to a system and method for warping a non-frontal facial image of an individual, e.g., a profile/partial view on to the full frontal facial image of that individual using conventional warping algorithms. When a partial view is warped on to a full frontal view, it is important that at least half of the face will be visible in the warped image. Then, utilizing techniques described in commonly-owned, copending U.S. patent application ______ [Attorney Docket 702052, D#14900] entitled SYSTEM AND METHOD OF FACE RECOGNITION THROUGH ½ FACES, and/or commonly-owned, co-pending U.S. patent application ______ [Attorney Docket 702054, D#14902] entitled SYSTEM AND METHOD OF FACE RECOGNITION USING PROPORTIONS OF LEARNED MODEL, the whole disclosure and contents of each of which are incorporated by reference as if fully set forth herein, the face may be recognized.

According to the invention, an algorithm for face recognition from an arbitrary face pose (up to 90 degrees) is provided. The algorithm relies on some techniques that may be known and already available to skilled artisans: 1) Face detection techniques; 2) Face pose estimation techniques; 3) Generic three-dimensional head modeling where generic head models are often used in computer graphics comprising of a set of control points (in three dimensions (3-D)) that are used to produce a generic head. By varying these points, a shape that will correspond to any given head may be produced, with a pre-set precision, i.e., the higher the number of points the better precision; 4) View morphing techniques, whereby given an image and a 3-D structure of the scene, an exact image may be created that will correspond to an image obtained from the same camera in the arbitrary position of the scene. Some view morphing techniques do not require an exact, but only an approximate 3-D structure of the scene and still provide very good results such as described in the reference to S. J. Gortler, R. Grzeszczuk, R. Szelisky and M. F. Cohen entitled “The lumigraph” SIGGRAPH 96, pages 43-54; and 5) Face recognition from partial faces, as described in commonly-owned, co-pending U.S. patent application Nos. ______ [Attorney Docket 702052, D#14900 and Attorney Docket 702054, D#14902].

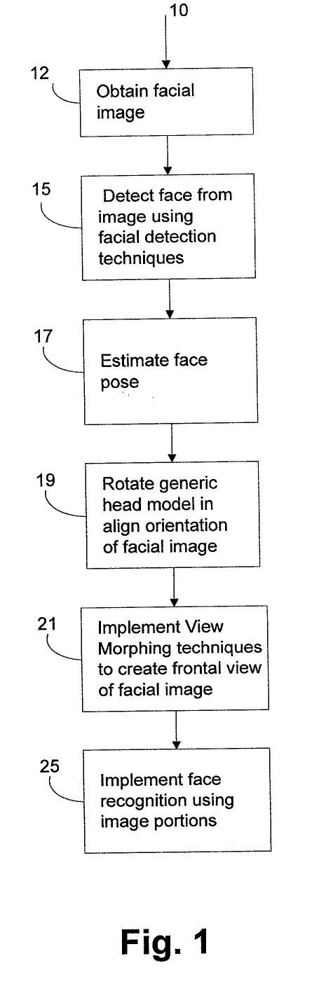

The algorithm 10 for face recognition may be executed according to the following steps as indicated in FIG. 1. As shown in FIG. 1, for a given image, a facial image is first obtained at step 12. Next at step 15, using any one of several face detection algorithms, for example, such as described in the reference to A. J. Colmenarez and T. S. Huang entitled “Maximum Likelihood Face Detection,” Second International Conference on Face and Gesture Recognition, pp.307-311, 1996, the whole contents and disclosure of which is incorporated by reference as if fully set forth herein, the facial image is detected. Some of these algorithms already provide approximate information about the face pose such as described in the reference to S. Gutta, J. Huang, P. J. Phillips and H. Wechsler, entitled “Mixture of Experts for Classification of Gender, Ethnic Origin, and Pose of Human Faces,” IEEE Transactions on Neural Networks, 11(4): 948-960, July 2000. Then, as indicated at step 17, the head pose is found in the manner such as suggested in the reference to Z. Liu. Z. Zhang entitled “Robust Head Motion Computation by Taking Advantage of Physical Properties,” Workshop on Human Motion, pp. 73-77, Austin 2000, the whole contents and disclosure of which is incorporated by reference as if fully set forth herein. A preferred algorithm that may be used is described in commonly-owned, co-pending U.S. patent application ______ [Attorney Docket 702498, D#14903] entitled HEAD MOTION ESTIMATION FROM FOUR FEATURE POINTS, the whole disclosure and contents of which are incorporated by reference as if fully set forth herein, which describes a four-point algorithm for finding a head pose from the minimal number of point matches, which is four.

Then, the next step 19 as shown in FIG. 1, involves the step of rotating a generic head model (GHM) so that it has the same orientation as the given face image. The GHM is translated and scaled so that the outer eye corners coincide with the given face. The GHM is then modified so that other detectable features (mouth features, nostrils, tip of the nose, ear features, eye brows, etc.) correspond to those on the given face image. At this point, the obtained GHM does not have exactly the same shape as the given face, but is a very good approximation. Then, as indicated at step 21, using view morphing techniques, the image is recreated so that a frontal view of the face is obtained. This step essentially involves, rotating the camera, so that head pose angles are 0,0,0, and then translating the camera so that face appears in the center of the image. Since view morphing techniques may recreate only a visible part of the scene, it will not be able to recreate a complete, but only a partial face. However, as shown in step 25 of FIG. 1, face recognition may be performed from a half face image only, or any greater portion, so reliable results may still be obtained such as described in view of herein-incorporated, commonly-owned, co-pending U.S. patent application Nos. ______ [Attorney Docket 702052, D#14900 and Attorney Docket 702054, D#14902].

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for classifying facial images from a partial view of a facial image, the method comprising the steps of:
a) training a classifier device for recognizing facial images, said classifier device being trained with input data associated with a facial image of a subject;
b) detecting a partial view of a subject's facial image; and,
c) warping said partial view of the subject's facial image onto a frontal image to obtain a warped image of said subject; and,
d) classifying said warped image according to a classification method performed by said trained classifier device.

2. The method of claim 1, wherein said obtaining step b), includes the step of implementing a face detection algorithm.

3. The method of claim 1, wherein said warping step c) comprises the steps of:
finding a head pose of said detected partial view;
defining a generic head model and rotating said generic head model (GHM) so that it has the same orientation as the given face image;
translating and scaling said GHM so that one or more features of said GHM coincide with the given face image
recreating said image to obtain a frontal view of the face.

4. The method of claim 3, wherein said step of finding a head pose of said detected partial view comprises the step of implementing an algorithm to find a head pose from a minimal number of point matches.

5. The method of claim 4, wherein said algorithm comprises a four-point algorithm wherein the minimal number of match points is four.

6. The method of claim 4, further including the step of modifying said GHM so that other detectable features of said GHM correspond to those on the given face image.

7. The method of claim 6, wherein said detectable features of said GHM includes one or more of mouth features, nostrils, tip of the nose, ear features, eye brows.

8. The method of claim 6, wherein said image recreating step includes the step of utilizing view morphing techniques to recreate a partial face view, said partial face view comprising said warped image to be classified.

9. The method of claim 1, wherein said classifying step d) includes implementing a Radial Basis Function Network.

10. An apparatus for classifying facial images from a partial view of a facial image, the apparatus comprising:
a) a classifier device for recognizing facial images, said classifier device being trained with input data associated with a facial image of a subject;
b) mechanism for obtain a warped image of said subject, said mechanism including detecting a partial view of a subject's facial image and warping said partial view of the subject's facial image onto a frontal image of said subject; wherein said warped image is input to said trained classifier device for classifying said warped image.

11. A program storage device readable by machine, tangibly embodying a program of instructions executable by the machine to perform method steps for classifying facial images from a partial view of a facial image, the method comprising the steps of:
a) training a classifier device for recognizing facial images, said classifier device being trained with input data associated with a facial image of a subject;
b) detecting a partial view of a subject's facial image; and,
c) warping said partial view of the subject's facial image onto a frontal image to obtain a warped image of said subject; and,
d) classifying said warped image according to a classification method performed by said trained classifier device.
